(19) United States
(12) Patent Application Publication
(10) Pub. No.: US 2025/0149020 A1
(43) Pub. Date: May 8, 2025

(54) METHOD OF CONSTRUCTING TRAINING DATASET FOR SPEECH SYNTHESIS THROUGH FUSION OF LANGUAGE, SPEAKER, AND EMOTION WITHIN UTTERANCE

(71) Applicant: Korea Electronics Technology Institute, Seongnam-si (KR)

(72) Inventors: Young Han LEE, Seongnam-si (KR); Tae Woo KIM, Seongnam-si (KR); Choong Sang CHO, Seongnam-si (KR)

(73) Assignee: Korea Electronics Technology Institute, Seongnam-si (KR)

(21) Appl. No.: 18/396,025

(22) Filed: Dec. 26, 2023

(30) Foreign Application Priority Data
Nov. 6, 2023 (KR) 10-2023-0151356

(51) Int. Cl. G10L 13/027; G10L 13/08

(52) U.S. Cl. CPC G10L 13/027; G10L 13/08

(57) ABSTRACT

There is provided a training dataset construction method for speech synthesis through fusion of language, speaker, emotion within an utterance. A training dataset construction method of a speech synthesis model according to an embodiment collects speech data having different speech utterance information, increases the speech data by fusing the collected speech data within one utterance, and generates a training dataset by using the increased speech data. Accordingly, a training dataset for speech synthesis is constructed through fusion of language, speaker, emotion within one utterance, so that quality of speech synthesis of multi-speaker/multi-language/emotion can be enhanced.

### CROSS-REFERENCE TO RELATED APPLICATION(S) AND CLAIM OF PRIORITY

This application is based on and claims priority under 35 U.S.C. § 119 to Korean Patent Application No. 10-2023-0151356, filed on Nov. 6, 2023, in the Korean Intellectual Property Office, the disclosure of which is herein incorporated by reference in its entirety.

### BACKGROUND

### Field

The disclosure relates to deep learning model training, and more particularly, to a method for constructing a dataset for training a speech synthesis model.

### Description of Related Art

Speech synthesis technologies have developed to the extent that real human-like voices in terms of quality can be generated, and multi-speaker, emotion utterance, and multi-language speech synthesis technologies are being researched according to an application field.

In the case of multi-speaker, emotion utterance, and multi-language speech synthesis, there are various types of voices that should be matched compared to limited texts, and thus, various researches are being conducted to solve the one-to-many problem. To solve this problem, speech data acquired by speakers, emotions, and languages are required, and information for distinguishing data by speakers, emotions, and languages should be provided as label information in addition to speech texts, and a speech synthesizer should be trained with this information.

Accordingly, datasets generated by a single speaker capable of expressing various languages, emotions, rhythms and pronunciations should be acquired. However, this is realistically impossible. This is because a normal person can hardly speak multiple languages fluently while changing emotions, and a method of using voice actors has a problem of high costs.

### SUMMARY

The disclosure has been developed in order to solve the above-described problems, and an object of the disclosure is to provide, as a solution for enhancing quality of multi-speaker/multi-language/emotion speech synthesis, a method for constructing a training dataset for speech synthesis through fusion of language, speaker, emotion within an utterance.

According to an embodiment of the disclosure to achieve the above-described object, a training dataset construction method of a speech synthesis model may include: a step of collecting speech data having different speech utterance information; a step of increasing the speech data by fusing the collected speech data within one utterance; and a step of generating a training dataset by using the increased speech data.

The training dataset may include a text on speech data and speech utterance information as input data of the speech synthesis model, and the training dataset may include speech data as output data of the speech synthesis model.

The speech utterance information may include at least one of a language of a text, a speaker uttering the text, and an emotion of the speaker uttering the text.

The step of increasing may include fusing speech data of different languages within one utterance according to time series.

The step of increasing may include fusing speech data of different speakers within one utterance according to time series.

The step of increasing may include fusing speech data of different languages and different speakers within one utterance according to time series.

The step of increasing may include fusing speech data of different within one utterance emotions according to time series.

The step of increasing may include fusing speech data of different paralinguistic expressions within one utterance according to time series.

The training dataset construction method may further include a step of training the speech synthesis model with the generated training dataset.

According to another aspect of the disclosure, there is provided a training dataset construction system of a speech synthesis model including: a processor configured to collect speech data having different speech utterance information, to increase the speech data by fusing the collected speech data within one utterance, and to generate a training dataset by using the increased speech data; and a storage unit configured to store the generated training dataset.

According to still another aspect of the disclosure, there is provided a training method of a speech synthesis model including: a step of increasing speech data by fusing speech data having different speech utterance information within one utterance; a step of generating a training dataset by using the increased speech data; and a step of training the speech synthesis model with the generated training dataset.

As described above, according to embodiments of the disclosure, a training dataset for speech synthesis is constructed through fusion of language, speaker, emotion within one utterance, so that quality of speech synthesis of multi-speaker/multi-language/emotion can be enhanced.

In particular, according to various embodiments of the disclosure, various speeches, such as an utterance that includes a foreigner mimicking other languages, speaking English in a Korean text, imitating other people's messages during a conversation, can be synthesized, so that a more immersive dubbing service can be provided.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating speech data for constructing a training dataset for multi-speaker-based multi-language (English/Korean) speech synthesis;

FIG. 2 is a view illustrating examples of speech data which result from merging of speech data of different languages in one utterance;

FIG. 3 is a view illustrating a concept of a method for constructing a training dataset for a multi-speaker-based multi-language speech synthesis model according to an embodiment of the disclosure;

FIG. 4 is a flowchart illustrating a method for constructing a training dataset for a multi-speaker-based multi-language speech synthesis model according to an embodiment of the disclosure; and

FIG. 5 is a view illustrating a training dataset construction system for a multi-speaker-based multi-language speech synthesis model according to another embodiment of the disclosure.

### DETAILED DESCRIPTION

Hereinafter, the disclosure will be described in more detail with reference to the accompanying drawings.

Embodiments of the disclosure provide a method for constructing a training dataset for speech synthesis through fusion of language, speaker, emotion within an utterance.

The disclosure relates to a technology for training a speech synthesis model to be able to synthesize a speech even when language/rhythm, speaker/pronunciation, emotion utterance are complicatedly intertwined, and specifically, to a technology for constructing a training dataset in which two or more kinds of speech data are fused within one utterance according to time series.

In embodiments of the disclosure, by fusing speech data to be able to process language/rhythm, speaker/pronunciation, emotion information differently according to time series, and using a ground truth corresponding to the speech data, language/rhythm, speaker/pronunciation, emotion information according to time series may be decomposed and each component may be applied according to a specific purpose.

In addition, it is possible to increase a training dataset in various combinations of elements of language/rhythm, speaker/pronunciation, emotion information, and hence, a training data set of a high capacity can be constructed at a low cost without additional data.

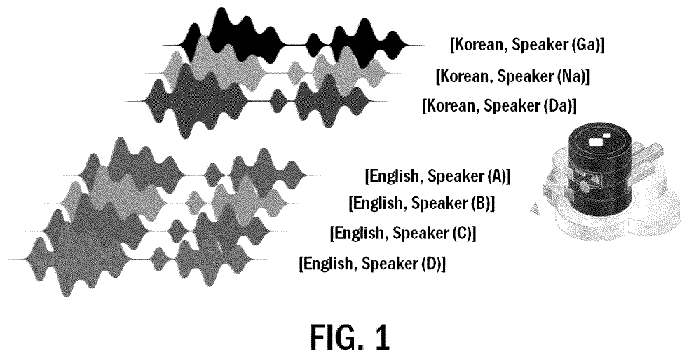

FIG. 1 is a view illustrating examples of speech data for constructing a training dataset for multi-speaker-based multi-language (English/Korean) speech synthesis.
Specifically, 1) first speech data is speech data that is obtained when a “speaker (Ga)” speaks a “Korean” text,
2) second speech data is speech data that is obtained when a “speaker (Na)” speaks a “Korean” text,
3) third speech data is speech data that is obtained when a “speaker (Da)” speaks a “Korean” text,
4) fourth speech data is speech data that is obtained when a “speaker (A)” speaks an “English” text,
5) fifth speech data is speech data that is obtained when a “speaker (B)” speaks an “English” text,
6) sixth speech data is speech data that is obtained when a “speaker (C)” speaks an “English” text, and
7) seventh speech data is speech data that is obtained when a “speaker (D)” speaks an “English” text.

A training dataset for a speech synthesis model is generated by adding information on an audiotext, speakers (Ga, Na, Da, A, B, C, D) and languages (Korean, English) to the above-described speech data. The generated training dataset may have limitations to training the speech synthesis model to be able to synthesize a corresponding speech even when there is a change in language, pronunciation (speaker characteristics) with time, such as when a Korean speaker speaks English in the middle of speaking Korean, or mimics other people.

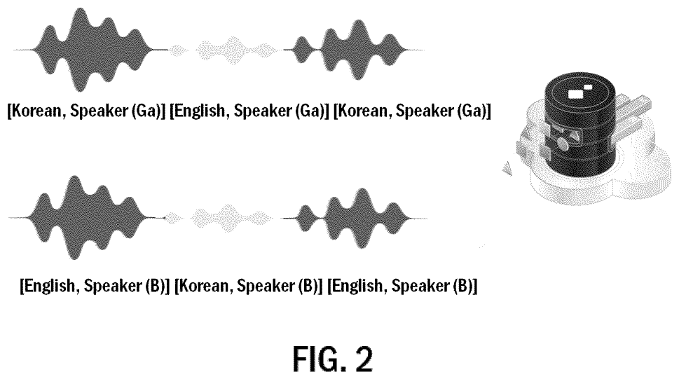

Speech data for constructing a training dataset to solve this problem is illustrated in FIG. 2. 1) First speech data is speech data that is obtained when the “speaker (Ga)” utters an “English text” in the middle of uttering a “Korean” text and then utters a “Korean” text again, and 2) second speech data is speech data that is obtained when the “speaker (B)” utters a “Korean” text in the middle of uttering a “English” text and then utters an “English text” again.

The above-described speech data is speech data that is obtained when the same speaker utters while changing language according to time series. However, such speech data is obtained by inducing speakers to utter in corresponding ways and then recording, and thus, an additional cost may be incurred, and this method would be impossible if a foreigner does not know Korean.

In addition, since there are different languages within one utterance, it takes much effort, time, and cost to label a ground truth for training.

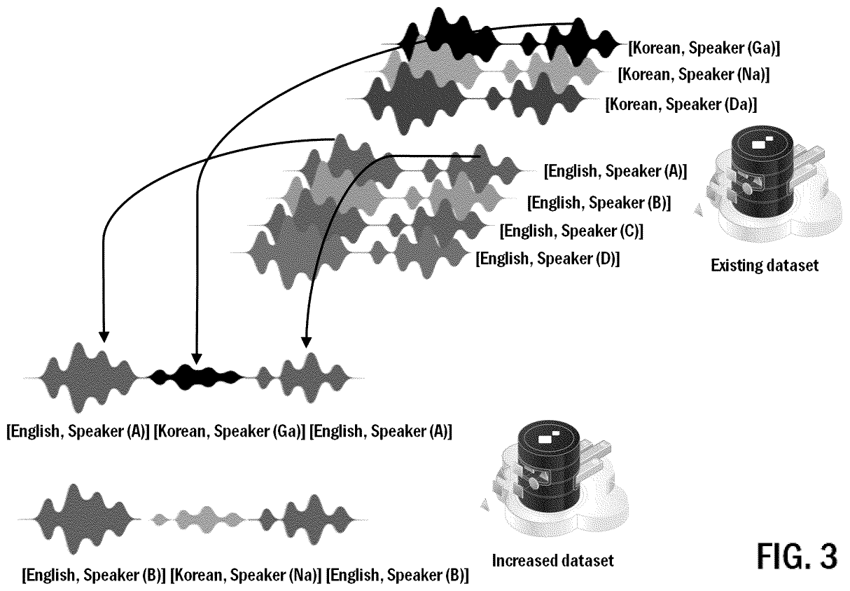

FIG. 3 is a view illustrating a concept of a method for constructing a training dataset for a multi-speaker-based multi-language speech synthesis model according to an embodiment of the disclosure. The method illustrated in FIG. 3 is for increasing speech data by fusing speech data that has different languages and different speakers as shown in FIG. 1 within one utterance according to time series.

Through this, the speech synthesis model learns a change in a synthesized speech caused by a change in speech utterance information according to time, so that the speech synthesis model can make various changes in speech utterance information with time with little effort and cost, compared to a related-art model which synthesizes a speech based on unified language, speaker.

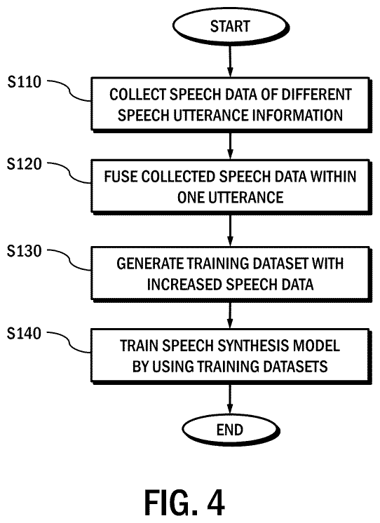

FIG. 4 is a flowchart illustrating a method for constructing a training dataset for a multi-speaker-based multi-language speech synthesis model according to an embodiment of the disclosure.

Speech data having different speech utterance information, specifically, speech data having different languages of texts and different speakers uttering texts, is collected to construct a training dataset of a multi-speaker-based multi-language speech synthesis model (S110). Speech data collected in step S110 refers to speech data illustrated in FIG. 1.

The speech data is increased by fusing the speech data collected in step S110 within one utterance (S120). The speech data fused in step S120 includes not only speech data having different speakers or different languages but also speech data having both different speakers and different languages. The fused speech data corresponds to speech data illustrated in FIG. 3.

Training datasets are generated by using the speech data increased in step S120 (S130). The generated training dataset includes a text on speech data and speech utterance information (language, speaker) as input data of the speech synthesis model, and includes speech data as output data of the speech synthesis model.

The multi-speaker-based multi-language speech synthesis model is trained by using the training datasets generated in step S130 (S140).

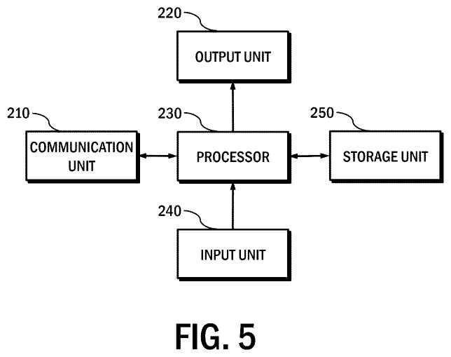

FIG. 5 is a view illustrating a configuration of a training dataset construction system for a multi-speaker-based multi-language speech synthesis model according to another embodiment of the disclosure. As shown in FIG. 5, the training dataset construction system according to another embodiment may be implemented by a computing system which includes a communication unit 210, an output unit 220, a processor 230, an input unit 240, and a storage unit 250.

The communication unit 210 is a communication interface for connecting to an external network or an external device, the output unit 220 is an output means for displaying a result of computing by the processor 230, and the input unit 240 is a user interface for receiving a user command and delivering the user command to the processor 230.

The processor 230 generates a training dataset by fusing speech data having different speakers and different languages within one utterance, and trains a speech synthesis model with the generated training dataset according to the procedure of FIG. 4 described above.

The storage unit 250 is a repository in which training datasets generated by the processor 230 are stored. In addition, the storage unit 250 provides a storage space necessary for functions and operations of the processor 230.

Up to now, a method and a system for constructing a training dataset for a multi-speaker-based multi-language speech synthesis model have been described in detail with reference to preferred embodiments.

The above-described embodiments provide a method for enhancing quality of speech synthesis of multi-speaker/multi-language/multi-emotion, which is restrictedly used since language/rhythm, speaker/pronunciation, emotion cannot be decomposed according to time series, and for constructing a training dataset with little effort, time, cost by using existing data.

Accordingly, various speeches, such as an utterance that includes a foreigner mimicking other languages, speaking English in a Korean text, imitating other people's messages during a conversation, can be synthesized, so that a more immersive dubbing service can be provided.

A training dataset can be generated by fusing speech data having different emotions of a speaker uttering a text, in addition to different languages and different speakers, or a training dataset can be generated by fusing speech data having different paralinguistic expressions of a speaker. That is, generating a training dataset by fusing speech data having different languages, different speakers, different emotions, different paralinguistic expressions within one utterance belongs to the scope of the disclosure.

Furthermore, in fusing speech data, only a part of speech data rather than all speech data may be extracted and fused. Furthermore, a training dataset can be increased by variously fusing generated training datasets.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A training dataset construction method of a speech synthesis model, the method comprising:
a step of collecting speech data having different speech utterance information;
a step of increasing the speech data by fusing the collected speech data within one utterance; and
a step of generating a training dataset by using the increased speech data.

2. The training dataset construction method of claim 1, wherein the training dataset includes a text on speech data and speech utterance information as input data of the speech synthesis model,
wherein the training dataset includes speech data as output data of the speech synthesis model.

3. The training dataset construction method of claim 2, wherein the speech utterance information includes at least one of a language of a text, a speaker uttering the text, and an emotion of the speaker uttering the text.

4. The training dataset construction method of claim 3, wherein the step of increasing comprises fusing speech data of different languages within one utterance according to time series.

5. The training dataset construction method of claim 3, wherein the step of increasing comprises fusing speech data of different speakers within one utterance according to time series.

6. The training dataset construction method of claim 3, wherein the step of increasing comprises fusing speech data of different languages and different speakers within one utterance according to time series.

7. The training dataset construction method of claim 3, wherein the step of increasing comprises fusing speech data of different within one utterance emotions according to time series.

8. The training dataset construction method of claim 3, wherein the step of increasing comprises fusing speech data of different paralinguistic expressions within one utterance according to time series.

9. The training dataset construction method of claim 1, further comprising a step of training the speech synthesis model with the generated training dataset.

10. A training dataset construction system of a speech synthesis model, the system comprising:
a processor configured to collect speech data having different speech utterance information, to increase the speech data by fusing the collected speech data within one utterance, and to generate a training dataset by using the increased speech data; and
a storage unit configured to store the generated training dataset.

11. A training method of a speech synthesis model, the method comprising:
a step of increasing speech data by fusing speech data having different speech utterance information within one utterance;
a step of generating a training dataset by using the increased speech data; and
a step of training the speech synthesis model with the generated training dataset.
